(19) United States
(12) Patent Application Publication
(10) Pub. No.: US 2015/0088751 A1
(43) Pub. Date: Mar. 26, 2015

(54) TRANSACTION VERIFICATION SYSTEM BASED ON USER LOCATION

(71) Applicant: BANK OF AMERICA CORPORATION, Charlotte, NC (US)

(72) Inventors: David M. Grigg, Rock Hill, SC (US); Matthew A. Calman, Charlotte, NC (US); Marc I. Warshawsky, Charlotte, NC (US); Raja Bose, Charlotte, NC (US)

(21) Appl. No.: 14/558,986

(22) Filed: Dec. 3, 2014

Related U.S. Application Data
(63) Continuation of application No. 13/213,696, filed on Aug. 19, 2011.

(51) Int. Cl. G06Q 20/32; G06Q 20/40

(52) U.S. Cl. CPC G06Q 20/3224; G06Q 20/4016
USPC 705/44

(57) ABSTRACT

Embodiments of the invention provide misappropriation protection with user location verification. The methods, apparatus and computer program products provide for approving a transaction based at least partially on a determining that a mobile device associated with an account holder associated with a transaction is located within a predetermined distance from the location associated with the transaction. In some example implementations where the mobile device is located outside the predetermined distance from the location associated with the transaction, information associated with previously approved transactions is received and the transaction approved based at least partially on a determination that previously approved transaction have occurred at the same location.

### CLAIM OF PRIORITY UNDER 35 U.S.C. §119

This Non-Provisional Patent Application claims priority to Non-Provisional Application Ser. No. 13/213,696 titled “Fraud Protection With User Location Verification” filed Aug. 19, 2011, assigned to the assignee hereof and herby expressly incorporated by reference herein.

### FIELD

In general, embodiments of the invention relate to transaction verification associated with a commercial transaction, based on a pre-determined distance relationship between the user mobile device and a point-of-transaction.

### BACKGROUND

For many individuals, the use of plastic cards such as credit and debit cards has supplanted the use of cash, checks, or other negotiable instruments as the preferred means of paying for purchases. Many financial institutions and other businesses have recognized the popularity of plastic cards among such individuals and issued numerous credit, debit, and other cards linked to credit or bank accounts that allow customers to easily, rapidly, and conveniently make purchases in person, online, and over the phone. In response, customers have grown to appreciate and expect the speed and convenience afforded by plastic cards when making purchases, and it is no longer rare for a single individual to possess many plastic cards issued by numerous banks, retailers, service providers, and other businesses.

As the population of individuals who use plastic cards has grown, so too has the population of individuals who seek to improperly obtain an individual's plastic card information, represent themselves as the individual, and make unauthorized purchases and other financial transactions. Such unauthorized uses of an individual's plastic card information have widespread negative effects on the lives of individuals, and the larger economy. Beyond the damage to a customer's financial health, purchases and other unauthorized transactions represent a substantial portion of the losses suffered by retailers, financial institutions, and other businesses. Accordingly, there is a need to provide methods and systems that help protect individuals and businesses from misappropriation while preserving the speed and convenience associated with plastic card transactions.

### SUMMARY

The following presents a simplified summary of one or more embodiments in order to provide a basic understanding of such embodiments. This summary is not an extensive overview of all contemplated embodiments, and is intended to neither identify key or critical elements of all embodiments, nor delineate the scope of any or all embodiments. The summary's sole purpose is to present some concepts of one or more embodiments in a simplified form as a prelude to the more detailed description that is presented later.

Thus, further details are provided below for misappropriation protection with user location verification. In general terms, the methods, apparatus and computer program products herein described provide for determining whether a user's mobile device is located within a predetermined distance from a point-of-transaction, and approving the transaction if the user's mobile device is located within the predetermined distance.

Example embodiments in accordance with one aspect of the invention provide for an apparatus for protecting against an unauthorized transaction. In example implementations of such embodiments, the apparatus includes: a computing device including a memory and at least one processor and a misappropriation protection application stored in memory, executable by the processor, and configured to receive a set of information associated with a transaction, wherein the set of information associated with the transaction includes an identification of a geographic location associated with the transaction, receive a set of geographic location information associated with a mobile device, wherein the mobile device is associated with an account holder associated with the transaction, and determine, via a computing device processor, whether to approve or disapprove the transaction based at least partially on whether or not the mobile device is geographically located within a predetermined distance from the geographic location associated with the transaction.

In some such example implementations, the misappropriation protection application is further configured to approve the transaction at least partially based on a determination that the mobile device is geographically located within a predetermined distance from the geographic location associated with the transaction. In some such example implementations, and in other example implementations, the misappropriation protection application is further configured to receive a set of data associated with the account holder associated with the transaction, wherein the set of data includes information associated with a plurality of previously approved transactions, and wherein said misappropriation protection application is further configured to approve the transaction based at least partially on both determining that the mobile device is geographically located within the predetermined distance from the geographic location associated with the transaction and the information associated with a plurality of previously approved transactions.

In some example implementations, the misappropriation protection application is further configured to approve the transaction based at least partially on identifying via a computer device processor a previously approved transaction within the plurality of previously approved transactions, wherein the previously approved transaction is associated with the same location as the transaction.

In some example implementations of an apparatus, the misappropriation protection application is further configured to determine via a computing device processor that the mobile device is geographically located outside the predetermined distance from the geographic location associated with the transaction, and refer the transaction for further investigation based at least partially on determining via a computing device that the mobile device is geographically located outside the predetermined distance from the geographic location associated with the transaction.

In some such example implementations and in other example implementations, the misappropriation protection application is further configured to receive a set of data associated with the account holder associated with the transaction, wherein the set of data includes information associated with a plurality of previously approved transactions. In some such example implementations, the misappropriation protection application is further configured to approve the transaction based at least partially on identifying via a computer device processor a previously approved transaction within the plurality of previously approved transactions, wherein the previously approved transaction is associated with the same location as the transaction.

In some such example implementations, and in other example implementations, the misappropriation protection application is further configured to cause an alert to be transmitted to one or more devices associated with the account holder.

Example embodiments in accordance with another aspect of the invention provide for a method for protecting against an unauthorized transaction. Implementations of such methods include receiving a set of information associated with a transaction, wherein the set of information associated with the transaction includes an identification of a geographic location associated with the transaction, receiving a set of geographic location information associated with a mobile device, wherein the mobile device is associated with an account holder associated with the transaction, and determining, via a computing device processor, whether to approve or disapprove the transaction based at least partially on whether or not the mobile device is geographically located within a predetermined distance from the geographic location associated with the transaction.

In some example implementations, the method further includes approving the transaction at least partially based on a determination that the mobile device is geographically located within a predetermined distance from the geographic location associated with the transaction. In some such example implementations, and in other example implementations, the method further includes receiving a set of data associated with the account holder associated with the transaction, wherein the set of data includes information associated with a plurality of previously approved transactions.

In some example implementations, the method further includes approving the transaction based at least partially on identifying via a computer device processor a previously approved transaction within the plurality of previously approved transactions, wherein the previously approved transaction is associated with the same location as the transaction.

In some example implementations, the method includes determining via a computing device processor that the mobile device is geographically located outside the predetermined distance from the geographic location associated with the transaction, and referring the transaction for further investigation based at least partially on determining via a computing device that the mobile device is geographically located outside the predetermined distance from the geographic location associated with the transaction.

In some such example implementations and in other example implementations, the method includes receiving a set of data associated with the account holder associated with the transaction, wherein the set of data includes information associated with a plurality of previously approved transactions. In some such example implementations and in other example implementations, the method includes approving the transaction based at least partially on identifying via a computer device processor a previously approved transaction within the plurality of previously approved transactions, wherein the previously approved transaction is associated with the same location as the transaction. In some such example implementations an in other example implementations, the method includes causing an alert to be transmitted to one or more devices associated with the account holder.

Example embodiments in accordance with another aspect of the invention provide for a computer program product. Example implementations of such a computer program product include a non-transitory computer-readable medium including a first set of codes for causing a computer processor to be configured to receive a set of information associated with a transaction, wherein the set of information associated with the transaction includes an identification of a geographic location associated with the transaction, a second set of codes for causing a computer processor to be configured to receive a set of geographic location information associated with a mobile device, wherein the mobile device is associated with an account holder associated with the transaction, and a third set of codes for causing a computer processor to be configured to determine, via a computing device processor, whether to approve or disapprove the transaction based at least partially on whether or not the mobile device is geographically located within a predetermined distance from the geographic location associated with the transaction.

Some example implementations further include a set of codes for causing a computer processor to be configured to approve the transaction at least partially based on a determination that the mobile device is geographically located within a predetermined distance from the geographic location associated with the transaction. Some such example implementations and other example implementations include a set of codes for causing a computer processor to be configured to receive a set of data associated with the account holder associated with the transaction, wherein the set of data includes information associated with a plurality of previously approved transactions, and further causing a computer processor to be configured to approve the transaction based at least partially on both determining that the mobile device is geographically located within the predetermined distance from the geographic location associated with the transaction and the information associated with a plurality of previously approved transactions.

Some example implementations further include a set of codes for causing a computer processor to be configured to approve the transaction based at least partially on identifying a previously approved transaction within the plurality of previously approved transactions, wherein the previously approved transaction is associated with the same location as the transaction.

Some example implementations include a set of codes for causing a computer processor to be configured to determine via a computing device processor that the mobile device is geographically located outside the predetermined distance from the geographic location associated with the transaction, and a set of codes for causing a computer processor to be configured to refer the transaction for further investigation based at least partially on determining that the mobile device is geographically located outside the predetermined distance from the geographic location associated with the transaction.

Some such example implementations and other example implementations further include a set of codes for causing a computer processor to be configured to receive a set of data associated with the account holder associated with the transaction, wherein the set of data includes information associated with a plurality of previously approved transactions. Some such example implementations and other example implementations further include a set of codes for causing a computer processor to be configured to approve the transaction based at least partially on identifying a previously approved transaction within the plurality of previously approved transactions, wherein the previously approved transaction is associated with the same location as the transaction.

In some example implementations, the computer program product of further includes a set of codes for causing a computer processor to be configured to cause an alert to be transmitted to one or more devices associated with the account holder.

To the accomplishment of the foregoing and related ends, the one or more embodiments include the features hereinafter fully described and particularly pointed out in the claims. The following description and the annexed drawings set forth in detail certain illustrative features of the one or more embodiments. These features are indicative, however, of but a few of the various ways in which the principles of various embodiments may be employed, and this description is intended to include all such embodiments and their equivalents.

### BRIEF DESCRIPTION OF THE DRAWINGS

Having thus described embodiments of the invention in general terms, reference may now be made to the accompanying drawings:

FIG. 1 is a simplified diagram of a process flow in accordance with example embodiments of one aspect of the invention.

FIG. 2 is a more detailed block diagram of a process flow in accordance with example embodiments of one aspect of the invention.

FIG. 3 is a schematic diagram of an example system and environment in which example embodiments of one aspect of the invention may be implemented.

FIG. 3A is block diagram illustrating technical components of a mobile device configured for use in example implementations of one aspect of the invention.

### DETAILED DESCRIPTION OF EMBODIMENTS OF THE INVENTION

Embodiments of the present invention now may be described more fully hereinafter with reference to the accompanying drawings, in which some, but not all, embodiments of the invention are shown. Indeed, the invention may be embodied in many different forms and should not be construed as limited to the embodiments set forth herein; rather, these embodiments are provided so that this disclosure may satisfy applicable legal requirements. Like numbers refer to like elements throughout.

As may be appreciated by one of skill in the art, the present invention may be embodied as a method, system, computer program product, or a combination of the foregoing. Accordingly, the present invention may take the form of an entirely software embodiment (including firmware, resident software, micro-code, or the like) or an embodiment combining software and hardware aspects that may generally be referred to herein as a “system.” Furthermore, embodiments of the present invention may take the form of a computer program product on a computer-readable medium having computer-usable program code embodied in the medium.

Any suitable computer-readable medium may be utilized. The computer-readable medium may be, for example but not limited to, an electronic, magnetic, optical, electromagnetic, or semiconductor system, apparatus, or device. More specific examples of the computer readable medium include, but are not limited to, the following: a tangible storage medium such as a portable computer diskette, a hard disk, a random access memory (RAM), a read-only memory (ROM), an erasable programmable read-only memory (EPROM or Flash memory), a compact disc read-only memory (CD-ROM), or other optical or magnetic storage device.

Computer program code for carrying out operations of embodiments of the present invention may be written in an object oriented, scripted or unscripted programming language such as Java, Perl, Smalltalk, C++, SAS or the like. However, the computer program code for carrying out operations of embodiments of the present invention may also be written in conventional procedural programming languages, such as the “C” programming language or similar programming languages.

Embodiments of the present invention are described below with reference to flowchart illustrations and/or block diagrams of methods, apparatus (systems), and computer program products. It may be understood that each block of the flowchart illustrations and/or block diagrams, and/or combinations of blocks in the flowchart illustrations and/or block diagrams, can be implemented by computer program instructions. These computer program instructions may be provided to a processor of a general purpose computer, special purpose computer, or other programmable data processing apparatus to produce a machine, such that the instructions, which execute via the processor of the computer or other programmable data processing apparatus, create mechanisms for implementing the functions/acts specified in the flowchart and/or block diagram block or blocks.

These computer program instructions may also be stored in a computer-readable memory that can direct a computer or other programmable data processing apparatus to function in a particular manner, such that the instructions stored in the computer readable memory produce an article of manufacture including instruction means which implement the function/act specified in the flowchart and/or block diagram block(s).

The computer program instructions may also be loaded onto a computer or other programmable data processing apparatus to cause a series of operational steps to be performed on the computer or other programmable apparatus to produce a computer-implemented process such that the instructions which execute on the computer or other programmable apparatus provide steps for implementing the functions/acts specified in the flowchart and/or block diagram block(s). Alternatively, computer program implemented steps or acts may be combined with operator or human implemented steps or acts in order to carry out an embodiment of the invention.

Thus, further details are provided below for apparatuses, methods, and computer program products representing example implementations of embodiments of the present invention.

Some such embodiments contemplate a misappropriation prevention system that attempts to confirm the presence of an authorized user of an account at a point of sale (“POS”), point-of-transaction, or other location associated with a transaction. In implementations of such embodiments, the location of an individual's mobile device is used as an indicator of the location of that individual. As contemplated by some embodiments, if an individual's mobile device and plastic card or other account information are simultaneously collocated at a point-of-transaction, it is highly likely that the individual making the purchase or otherwise engaging in the transaction is an authorized user of the account that is being used in the transaction. Consequently, in situations where the mobile device and credit card, debit card, or other account information are at or near the same location, the likelihood that the transaction is misappropriationulent or unauthorized is diminished and it is likely that it is appropriate to approve the transaction.

Some example implementations contemplate situations where an authorized user's mobile device is not present or verifiable at a point-of-transaction, but the transaction is nonetheless legitimate and authorized. For example, an individual may have accidentally left their mobile device at home. Similarly, an individual may have left their mobile device in a car during a routine errand. In situations where a mobile device's battery has run out, or the mobile device is turned off or otherwise unable to provide accurate location information, it is possible that authorized transactions may not be recognized as such. In some such situations, example embodiments limit the degree of potential over-protection by taking into account the individual's history of prior approved transactions. For example, if an individual routinely goes to a particular dry cleaner and has previously made authorized purchases or payments at the dry cleaner, it is likely that all purchases at the dry cleaner charged to the individual's account are legitimate, even if the user's phone is not collocated at the point-of-transaction. In another example, an individual may make an unexpected payment to an auto-repair shop, and not have their mobile device with them. In such a situation, an example implementation may recognize that the user has made monthly car payments to the dealer associated with the repair shop, and recognize the transaction as likely to be authorized.

While many of the example implementations described herein contemplate detecting the position of a mobile device or other item associated with a user as an independent and/or initial form of authentication, it will be appreciated that the systems and methods described herein may be integrated into any approach to user authentication. For example, an implementation may examine an account holder's transaction history prior to determining whether a mobile device is collocated with a location associated with a transaction. In another example implementation, the position of a mobile device may be verified after another authentication sequence, such as the entry of a password or PIN number.

It will also be appreciated that the systems and methods described herein may be implemented in addition to and/or as supplements to other approaches to user authentication. For example, in some implementations, an authentication protocol may recognize an attempted transaction in a country, region, or other location that is atypical for the account holder and initially block or otherwise decline the transaction pending confirmation that a user's mobile device is located near the transaction. In some such example implementations, users who are travelling may avoid having legitimate transactions declined during their travels, while maintaining a degree of protection from unauthorized transactions that may occur due to lost or stolen account information.

The embodiments described herein may refer to use of a transaction or transaction event to trigger the location of the user and/or the user's mobile device. In various embodiments, occurrence of a transaction also triggers the sending of information such as offers and the like. Unless specifically limited by the context, a “transaction” refers to any communication between the user and the financial institution or other entity monitoring the user's activities. In some embodiments, for example, a transaction may refer to a purchase of goods or services, a return of goods or services, a payment transaction, a credit transaction, or other interaction involving a user's bank account. As used herein, a “bank account” refers to a credit account, a debit/deposit account, or the like. Although the phrase “bank account” includes the term “bank,” the account need not be maintained by a bank and may, instead, be maintained by other financial institutions. For example, in the context of a financial institution, a transaction may refer to one or more of a sale of goods and/or services, an account balance inquiry, a rewards transfer, an account money transfer, opening a bank application on a user's computer or mobile device, a user accessing their e-wallet or any other interaction involving the user and/or the user's device that is detectable by the financial institution. As further examples, a transaction may occur when an entity associated with the user is alerted via the transaction of the user's location. A transaction may occur when a user accesses a building, uses a rewards card, and/or performs an account balance query. A transaction may occur as a user's device establishes a wireless connection, such as a Wi-Fi connection, with a point-of-sale terminal. In some embodiments, a transaction may include one or more of the following: purchasing, renting, selling, and/or leasing goods and/or services (e.g., groceries, stamps, tickets, DVDs, vending machine items, or the like); withdrawing cash; making payments to creditors (e.g., paying monthly bills; paying federal, state, and/or local taxes and/or bills; or the like); sending remittances; transferring balances from one account to another account; loading money onto stored value cards (SVCs) and/or prepaid cards; donating to charities; and/or the like.

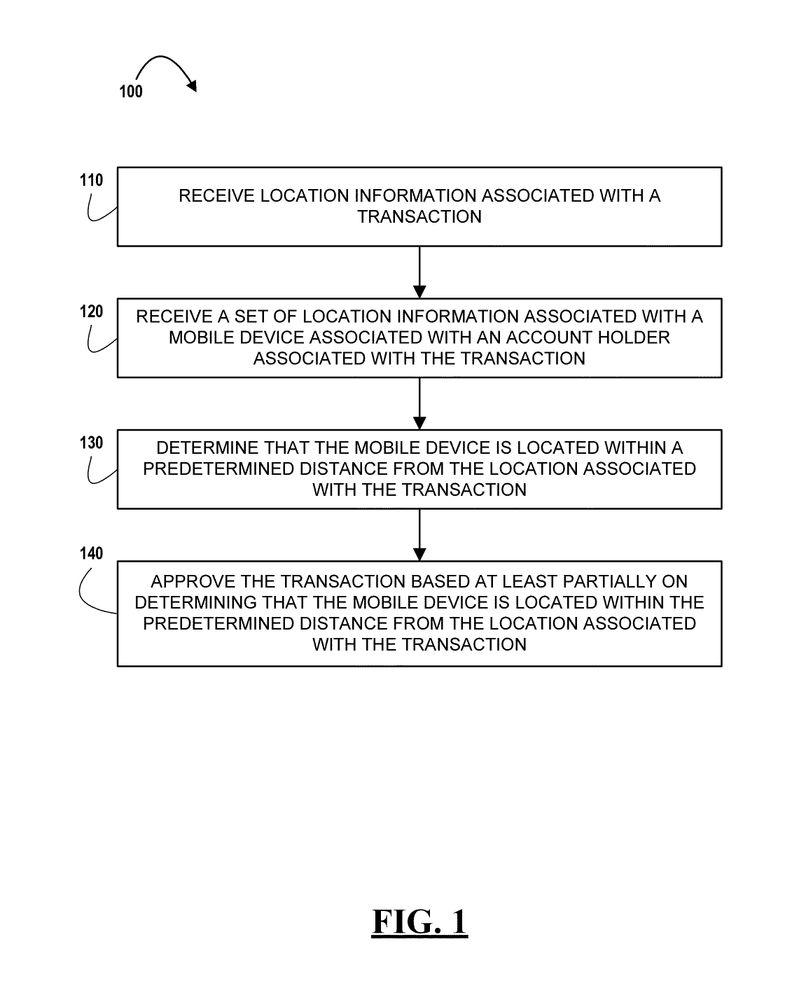

FIG. 1 presents a simplified block diagram of a process flow 100 in accordance with example implementations of one aspect of the invention. As shown in FIG. 1, process flow 100 includes 110-140. Element 110 includes receiving a set of location information associated with a transaction. It will be appreciated that any location information associated with a transaction may be used in example implementations of element 110. For example, the location information may include the address, GPS coordinates, longitude and latitude, location name, and/or any other information sufficient to identify a location associated with a transaction. It will also be appreciated that in implementations of element 110, the location associated with the transaction will typically be the location where an individual purporting to be an account holder presents a portion of their account information. For example, in many implementations, the location associated with a transaction is a physical store or other place of business where a user presents a plastic card such as a debit or credit card. However, it will be appreciated that the location could be a computer terminal or other user interface where an individual presents account information for making purchases or other transactions online. For example, the location associated with a transaction could be a home computer from which a user makes purchases, accesses account information, initiates fund transfers, or otherwise accesses account information.

It is appreciated that the transaction location information may be gathered in various manners. In one embodiment, the transaction data includes a geographic address associated with the point-of-transaction location. In other embodiments, the transaction data may include an identifier associated with the point-of-transaction merchant, which is used as a pointer to a database containing geographic location information associated with the point-of-transaction. For example, the point-of-transaction merchant may be a customer of the financial institution, in which case the financial institution maintains address information associated with the point-of-transaction merchant. When the financial transaction is received from the point-of-transaction merchant, the system may identify the point-of-transaction merchant and retrieve address information associated with the point-of-transaction merchant which can be converted to geographic location data associated with the location of the transaction. In another embodiment, the system may use name and other information associated with the point-of-transaction merchant to search public databases such point-of-transaction merchant's website(s), or the like to determine address and/or geographic location information associated with the point-of-transaction merchant. In some embodiments, the point-of-transaction device may transmit its geographic location along with the transaction data. For example, the point-of-transaction device may be a mobile device with a GPS receiver/transmitter for transmitting geographic location information indication the location where the transaction is occurring.

As shown in element 120, process flow 100 includes receiving a set of location information associated with a mobile device associated with an authorized user of an account. In example implementations of element 120, any type of location information, including the types of location information discussed in relation to element 110 may be received. For example, many mobile devices are capable of recognizing and transmitting the GPS coordinates for the position of the mobile device. In some situations, a mobile device may be capable of recognizing a wireless network provided by a store or otherwise associated with a particular location, such as an individual's home wireless network, and use that information to transmit or otherwise make available the location information associated with the mobile device. Some example implementations of element 120 contemplate an authorized user of an account providing information about their mobile device to the financial institution or other entity that administers the account. For example, an authorized user may identify a mobile phone, a laptop computer, or any of a number of mobile devices as associated with the authorized user, and allow the financial institution or other entities to receive information about the location of such mobile devices in the context of verifying transactions.

In some example implementations of element 120, accelerometer information and/or other directional information associated with a mobile device may be received. For example, accelerometer information associated with a device may indicate that the device is moving when ordinarily the device would be still during a transaction. In some example implementations, the accelerometer may indicate that a mobile device is moving away from a location associated with a transaction, which may indicate that the transaction is unauthorized. In other example implementations, a vector or other trajectory may be established based on, for example, a series of positions of the mobile device. In some such example implementations, it may be possible to establish that a mobile device is moving, such as when a user attempts to engage in a transaction during a flight, train ride, car ride, or otherwise in transit.

As shown in element 130, process flow 100 also includes determining that the mobile device is located within a predetermined distance from the location associated with the transaction. It will be appreciated that any approach to determining that the mobile device is located within a predetermined distance from the location associated with the transaction may be used in example implementations of element 130. For example, a computer processor may compare the GPS coordinates associated with the mobile device with the GPS coordinates associated with the location of the transaction and calculate a distance. It will be appreciated that the predetermined distance may be any distance sufficient to establish an increased probability that the individual purporting to be an authorized user of the account involved in the transaction is the authorized user. In some example implementations, such as situations where a store is relatively large, such as a grocery store, and/or in situations where the point-of-transaction is relatively isolated from other businesses, the predetermined distance may be several dozen meters, or even a larger distance. In some situations, such as in densely populated marketplaces or apartment buildings, where many distinct spaces are placed within close proximity to each other, the predetermined distance may be less than a meter, or less than a few meters, to establish a sufficient probability that the user of the account information is located in the same space or apartment as the authorized user. The predetermined distance is somewhat influenced by the margin of error associated with the relating to the location of the point-of-transaction terminal. The more accurate the location information associated with the transaction, the tighter range that can be selected for the predetermined distance.

Some example implementations contemplate one or more databases wherein location information is stored. For example, a database may store location information associated with the position of registers and/or other point-of-transaction devices within a store. In another example, a database may store information about the location of a store itself, such as whether a store is established as a stand-alone edifice or incorporated into a shopping center, shopping mall, open-air market, or other arrangement of points of sale. In some such examples, a predetermined distance associated with a particular point-of-transaction may be associated with and/or linked to location information stored in a database. For example, a store may select a particular predetermined distance based in part on the spacing of points of sale within the store. Other entities may select distances based on the size and/or orientation of a store. It will also be appreciated that a third party and/or the user of a mobile device may select a predetermined distance. For example, one user may choose to use a very short predetermined distance, while another user may select a larger distance. In some situations, a predetermined distance may take into account information about and/or associated with a point-of-transaction. For example, the type of goods or services offered by a particular entity may influence the calculation of a predetermined distance. In such a situation where a store specializes in high-end merchandise, such as a jewelry store or a boutique clothing store, the predetermined distance may be set to be relatively short. A store's history of crime and/or crime statistics for the area surrounding a store may also be taken into account in establishing a predetermined distance. For example, if an individual store or shopping center has experienced a number of occurrences where unauthorized transactions were made, the predetermined distance may be shortened to attempt to reduce the number of unauthorized transactions. It will be appreciated that these, and other factors may be combined and/or considered in determining the predetermined distance. It will also be appreciated that a store, user, and/or third party may establish one or more predetermined distances for use with different transactions.

As shown in element 140, process flow 100 also includes approving the transaction based at least partially on determining that the mobile device is located within the predetermined distance from the location associated with the transaction. It will be appreciated that any approach to approving the transaction may be used in implementations of element 140. For example, in some example implementations, a server associated with a financial institution may transmit an approval to a device at the point-of-transaction. In other example implementations, a device located at the point-of-transaction may hold or otherwise prevent the transaction from occurring absent an approval.

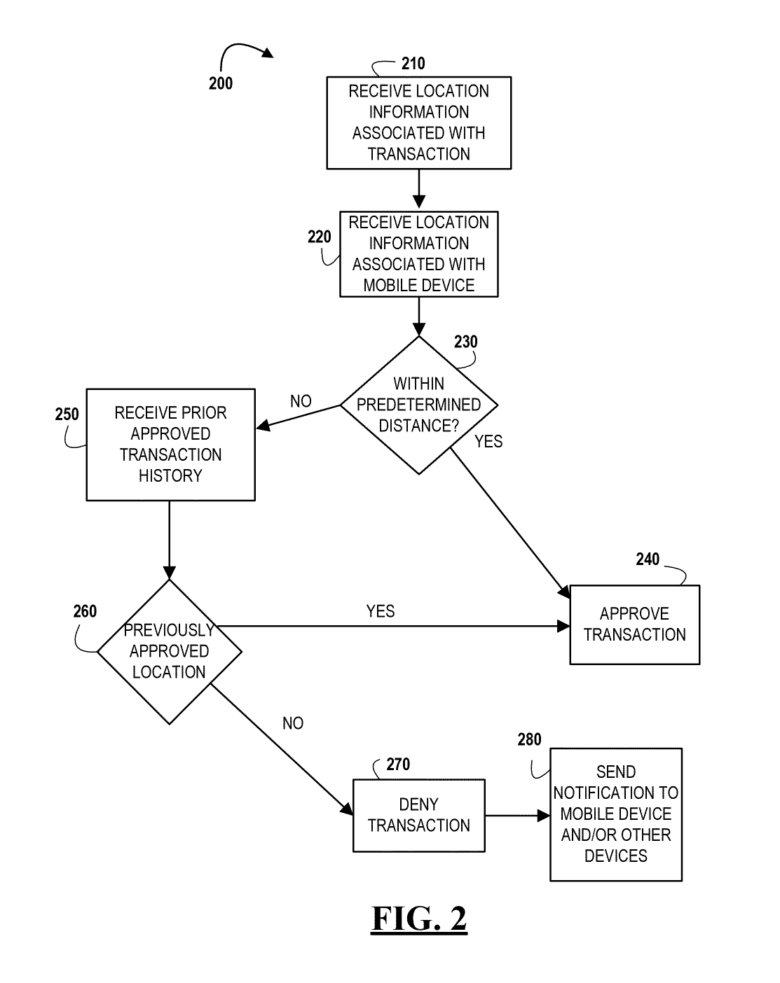

FIG. 2 presents a more detailed block diagram of a process flow 200 in accordance with some example implementations of an embodiment of the invention. It will be appreciated that example implementations of process flow 200 contemplate an attempted transaction wherein an individual presents account information and purports to be an authorized user of the account information. As shown at element 210, the process flow begins with receiving location information associated with the transaction. It will be appreciated that any approach to receiving location information associated with the transaction may be used in implementations of element 210, including but not limited to those approaches described and/or contemplated herein. After receiving location information associated with the transaction, process flow 200 includes element 220, which includes receiving location information associated with a mobile device that is associated with an authorized user of the account. It will be appreciated that any approach to receiving location information associated with the mobile device may be used in implementations of element 210, including but not limited to those approaches described and/or contemplated herein.

At element 230, process flow 200 includes determining whether the mobile device is within a predetermined distance from the transaction. If the device is within the predetermined distance, it is likely that the transaction is legitimate and authorized, and process flow 200 proceeds to approve the transaction at element 240. If the mobile device is not located with the predetermined distance from the transaction, more processing is necessary before the transaction can be approved. At element 250, information about previous approved purchases is received, and process 200 proceeds to element 260, where it is determined whether the location of the transaction is a location where a previously approved transaction has occurred. If so, process flow 200 proceeds to element 240, where the transaction is approved. If the location is not a location where a previously approved transaction has occurred, and since the user's mobile device is not sufficiently collocated with the transaction, there is an increased probability that the transaction is not authorized, and process flow 200 proceeds to element 270, where the transaction is denied. After denying the transaction, process flow 200 proceeds to element 280, which includes sending a notification to the user via a message to the user's mobile device, and any other devices that the authorized user has previously identified.

Some example implementations incorporate additional analysis of information associated with a user's past transactions. In some such example implementations, a time of day and/or time period associated with a transaction may be taken into account. For example, if a user typically purchases lunch at or around a particular time of day, a purchase made at a restaurant at or around that same time may be likely to be a legitimate transaction, and thus approved. In some such example implementations, and in other example implementations, the size and/or value of a transaction may be analyzed with reference to the size and/or value of previous transactions. For example, if a user routinely makes relatively small, but authorized purchases of music, film, and/or other media items at an electronics store or online, a purchase of expensive television, audio, and/or other high-end electronic equipment at the same store by someone purporting to be the user may be denied or referred for additional processing in the absence of other indicia of authorization, at least in part because the size and/or value of the transaction involving expensive equipment is dissimilar from the previously approved but much smaller and/or less valuable transactions. In some such example implementations and in other example implementations, patterns and/or cycles of previous transactions may be identified and analyzed when comparing a current transaction to information about a user's past transactions. For example, a user may exhibit a pattern of purchasing jewelry, toys, gifts, or other relatively costly items at particular times of year corresponding to time periods leading up to anniversaries, birthdays, holidays, and other recurring occasions. In another example, a user may exhibit a pattern of making a series of clothing and other purchases at the end of summer, corresponding to the period leading up to a child's return to school. In another example, a user may exhibit a history of periodically paying to have the oil changed in their car. In such example situations, an analysis of patterns and/or cycles of previous transactions may be incorporated into an analysis of a user's past transactions to identify transactions that are likely legitimate, even if the precise timing, size, and/or value of the transaction varies over time. It will be appreciated that any approach to analyzing and/or incorporating information associated with a user's past transactions may be use in example implementations of the systems and methods described herein.

It will be appreciated that while some examples described herein contemplate an analysis of a user's previous transactions in situations wherein the user's mobile device and a point-of-transaction are not collocated, it will be appreciated that an analysis of a user's previous transactions may be incorporated into example implementations in situations where the mobile device is located within a predetermined distance from a location associated with a transaction. Some such example implementations contemplate situations where a thief or other unauthorized user has acquired a user's phone and account information, such as situations where a bag, briefcase, backpack, purse, or other item holding a user's wallet and phone are taken. Some such example implementations and other example implementations contemplate using information associated with previous, approved transactions as an additional layer of security. For example, an authentication device residing on a network may supplement a determination that the mobile device is within a predetermined distance from a location associated with a transaction with information about previous transactions that indicate that the transaction is appropriate before transmitting a final approval of the transaction and/or otherwise allowing the transaction to proceed.

Some example implementations contemplate one or more transaction value thresholds that may be considered as part of a determination to accept and/or deny a transaction. For example, a predetermined threshold may be established such that transactions at and/or under a particular dollar value should be accepted, even if the mobile device is located outside of a predetermined distance. In another example implementation, a threshold may be established such that the mobile device must be located closer to the point-of-transaction for transactions valued at and/or over the threshold.

Some example implementations contemplate an ability for a user of a mobile device to override the denial or rejections of a transaction. In some such example implementations, prior to denying a transaction, a message is sent to the account user's mobile device and/or devices requesting that the user authenticate the transaction. It will be appreciated that any approach to transmitting a message to a user's mobile device may be used in such implementations, including but not limited to the use of an application, such as a mobile application or mobile app. It will be appreciated that any approach to authenticating a transaction from a mobile device may be used in such example implementations. For example, a user may enter an authorization code, such as a PIN number or some other predetermined password or code. In other examples, the user may select a link or other image presented on the display of the user's mobile device. In some such examples, and in other example implementations, the user of the mobile device may authenticate a transaction verbally, such as in response to an automated prompt or in conversation with a customer service representative. In some example situations where a user's mobile device is fitted with a digital camera, a user may authenticate the transaction visually by capturing and transmitting an image of the user or another image that denotes an authorization.

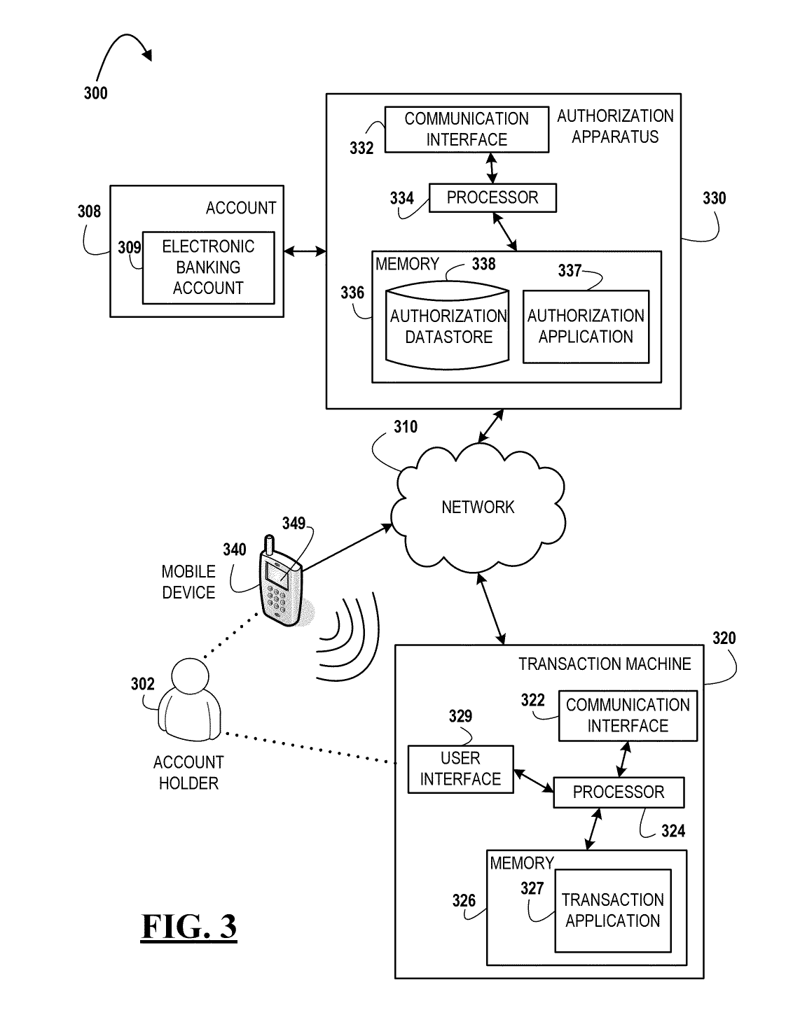

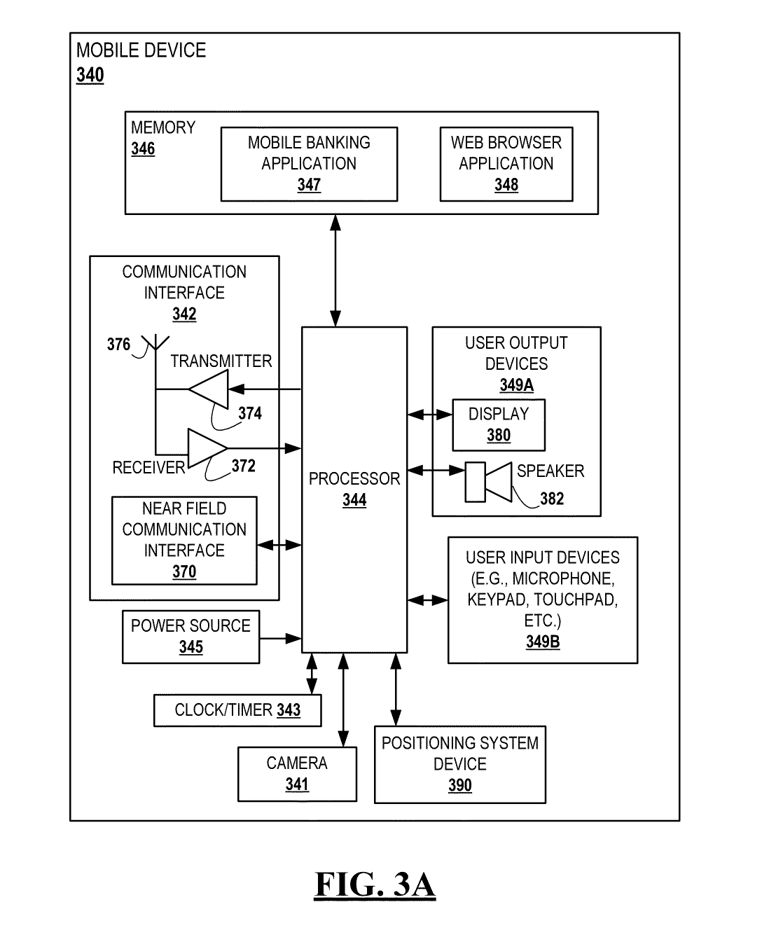

Referring now to FIG. 3, a system 300 for providing a misappropriation protection service is provided, in accordance with an embodiment of the present invention. As illustrated, the system 300 includes a network 310, a transaction machine 320, an authorization apparatus 330, and a mobile device 340. FIG. 3 also shows an account holder 302 and an account 308. The account 308 (e.g., credit account, deposit account, or the like) is associated with a banking account 309 (e.g., credit account, debit account, online banking account, mobile banking account, or the like). As shown, the holder 302 is associated with the mobile device 340 and the transaction machine 320. In accordance with some example implementations, the transaction machine 320 and the authorization apparatus 330 are each maintained and/or controlled by the same financial institution. For example, in some embodiments, the holder 302 is a customer of the financial institution, the authorization apparatus 330 is embodied as an ATM transaction server maintained by the financial institution, and the transaction machine 320 is embodied as an ATM maintained by the financial institution. However, in other embodiments, the transaction machine 320 and the authorization apparatus 330 are maintained by separate entities. For example, in some embodiments, the transaction machine 320 is embodied as a POS and/or a point-of-transaction device maintained by a merchant, and the authorization apparatus 330 is embodied as an authorization server maintained by a financial institution. In accordance with some example implementations, the mobile device 340 is associated with the holder 302 and/or is carried, owned, possessed, and/or owned by the holder 302.

As shown in FIG. 3, the transaction machine 320, the authorization apparatus 330, and the mobile device 340 are each operatively and selectively connected to the network 310, which may include one or more separate networks. The network 310 may include one or more payment networks, telephone networks (e.g., cellular networks, CDMA networks, any wireline and/or wireless network over which communications to telephones and/or mobile phones are sent, or the like), local area networks (LANs), wide area networks (WANs), global area networks (GANs) (e.g., the Internet, or the like), and/or one or more other telecommunications networks. For example, in some embodiments, the network 310 includes a telephone network (e.g., for communicating with the mobile device 340, or the like) and a payment network (e.g., for communicating with the transaction machine 320, or the like). It will also be appreciated that the network 310 may be secure and/or unsecure and may also include wireless and/or wireline technology.

The transaction machine 320 may include any computerized apparatus that can be configured to perform any one or more of the functions of the transaction machine 320 described and/or contemplated herein. It will also be understood that the transaction machine 320 can include and/or be embodied as, any transaction machine described and/or contemplated herein. It will further be understood that the transaction machine 320 can initiate, perform, complete, and/or otherwise facilitate any transaction described and/or contemplated herein as being initiated, performed, and/or otherwise facilitated by a transaction machine. For example, in some embodiments, the transaction machine 320 includes and/or is embodied as an ATM, a POS device, a self-checkout machine, a vending machine, a ticketing kiosk, a personal computer, a gaming device, a mobile phone, and/or the like. As another example, in some embodiments, the transaction machine 320 is configured to initiate, perform, complete, and/or otherwise facilitate one or more financial and/or non-financial transactions, including, for example, purchasing, renting, selling, and/or leasing goods and/or services (e.g., groceries, stamps, tickets, gift certificates, DVDs, or the like); withdrawing cash; making deposits (e.g., cash, checks, or the like); making payments (e.g., paying telephone bills, sending remittances, or the like); accessing the Internet; and/or the like.

In some embodiments, the transaction machine 320 (and/or one or more other portions of the system 300) requires its users to authenticate themselves to the transaction machine 320 before the transaction machine 320 will initiate, perform, complete, and/or facilitate a transaction. For example, in some embodiments, the transaction machine 320 (and/or the transaction application 327) is configured to authenticate a transaction machine user based at least partially on an ATM/debit/credit card, loyalty/rewards/club card, smart card, token (e.g., USB token, or the like), username/password, personal identification number (PIN), biometric information, and/or one or more other credentials that the user presents to the transaction machine 320. Additionally or alternatively, in some embodiments, the transaction machine 320 is configured to authenticate a user by using one-, two-, or multi-factor authentication. For example, in some embodiments, the transaction machine 320 requires two-factor authentication, such that the holder 302 must provide a valid debit card and enter the correct PIN associated with the debit card in order to partially authenticate the holder 302 to the transaction machine 320.

As illustrated in FIG. 3, in accordance with some embodiments of the present invention, the transaction machine 320 includes a communication interface 322, a processor 324, a memory 326 having a transaction application 327 stored therein, and a user interface 329. In such embodiments, the processor 324 is operatively and selectively connected to the communication interface 322, the user interface 329, and the memory 326.

Each communication interface described herein, including the communication interface 322, generally includes hardware, and, in some instances, software, that enables a portion of the system 300, such as the transaction machine 320, to send, receive, and/or otherwise communicate information to and/or from the communication interface of one or more other portions of the system 300. For example, the communication interface 322 of the transaction machine 320 may include a modem, network interface controller (NIC), NFC interface, network adapter, network interface card, and/or some other electronic communication device that operatively connects the transaction machine 320 to another portion of the system 300, such as, for example, the authorization apparatus 330.

Each processor described herein, including the processor 324, generally includes circuitry for implementing the audio, visual, and/or logic functions of that portion of the system 300. For example, the processor may include a digital signal processor device, a microprocessor device, and various analog-to-digital converters, digital-to-analog converters, and other support circuits. Control and signal processing functions of the system in which the processor resides may be allocated between these devices according to their respective capabilities. The processor may also include functionality to operate one or more software programs based at least partially on computer-executable program code portions thereof, which may be stored, for example, in a memory device, such as in the transaction application 327 of the memory 326 of the transaction machine 320.

Each memory device described herein, including the memory 326 for storing the transaction application 327 and other information, may include any computer-readable medium. For example, the memory may include volatile memory, such as volatile random access memory (RAM) having a cache area for the temporary storage of data. Memory may also include non-volatile memory, which may be embedded and/or may be removable. The non-volatile memory may additionally or alternatively include an EEPROM, flash memory, and/or the like. The memory may store any one or more of portions of information used by the apparatus in which it resides to implement the functions of that apparatus.

As shown in FIG. 3, the memory 326 includes the transaction application 327. It will be understood that the transaction application 327 can be operable (e.g., usable, executable, or the like) to initiate, perform, complete, and/or facilitate one or more portions of any embodiment described and/or contemplated herein, such as, for example, one or more portions of the process flows 100 and/or 200 described herein. For example, in some embodiments, the transaction application 327 is operable to receive transaction information associated with a transaction. As another example, in some embodiments, the transaction application 327 is operable to determine, via processor 324, that the mobile device 340 associated with the holder 302 is located within or without a predetermined distance from a location associated with the transaction. As still another example, in some embodiments, the transaction application 327 is operable to receive, via the communication interface 322, information indicating that a transaction has been approved or disapproved. As another example, in some embodiments, the transaction application 327 is operable to approve or disapprove a transaction, based at least partially on a determination that the mobile device 340 associated with the holder 302 is located within or outside a predetermined distance from a location associated with the transaction. In some embodiments, the transaction application 327 is operable to complete one or more transactions at the transaction machine 320 (e.g., complete a purchase transaction, dispense cash, accept a check for deposit, or the like).

In some embodiments, where the transaction machine 320 includes and/or is embodied as an ATM, the transaction application 327 is configured to execute on the ATM in order to initiate, perform, complete, and/or facilitate, for example, one or more cash withdrawals, deposits, and/or the like. In other embodiments, where the transaction machine 320 includes and/or is embodied as a point-of-transaction device, the transaction application 327 is configured to execute on the point-of-transaction device in order to initiate, perform, complete, and/or facilitate, for example, one or more debit card and/or credit card transactions. In still other embodiments, where the transaction machine 320 includes and/or is embodied as a personal computer, the transaction application 327 is configured to execute on the personal computer, and, in some embodiments, the transaction application 327 is embodied as a web browser (i.e., for navigating the Internet, or the like) that is operable to initiate, perform, complete, and/or otherwise facilitate one or more financial and/or non-financial transactions.

In some embodiments, the transaction application 327 is operable to enable the holder 302 and/or transaction machine 320 to communicate with one or more other portions of the system 300, and/or vice versa. In some embodiments, the transaction application 327 is additionally or alternatively operable to initiate, perform, complete, and/or otherwise facilitate one or more financial and/or non-financial transactions. In some embodiments, the transaction application 327 includes one or more computer-executable program code portions for causing and/or instructing the processor 324 to perform one or more of the functions of the transaction application 327 and/or transaction machine 320 described and/or contemplated herein. In some embodiments, the transaction application 327 includes and/or uses one or more network and/or system communication protocols.

As shown in FIG. 3, the transaction machine 320 also includes the user interface 329. It will be understood that the user interface 329 (and any other user interface described and/or contemplated herein) can include and/or be embodied as one or more user interfaces. It will also be understood that, in some embodiments, the user interface 329 includes one or more user output devices for presenting information and/or one or more items to the transaction machine user (e.g., the holder 302, or the like), such as, for example, one or more displays, speakers, receipt printers, dispensers (e.g., cash dispensers, ticket dispensers, merchandise dispensers, or the like), and/or the like. In some embodiments, the user interface 329 additionally or alternatively includes one or more user input devices, such as, for example, one or more buttons, keys, dials, levers, directional pads, joysticks, keyboards, mouses, accelerometers, controllers, microphones, touchpads, touchscreens, haptic interfaces, styluses, scanners, biometric readers, motion detectors, cameras, card readers (e.g., for reading the magnetic strip on magnetic cards such as ATM, debit, credit, and/or bank cards, or the like), deposit mechanisms (e.g., for depositing checks and/or cash, or the like), and/or the like for receiving information from one or more items and/or from the transaction machine user (e.g., the holder 302, or the like). In some embodiments, the user interface 329 and/or the transaction machine 320 includes one or more vaults, security sensors, locks, and/or anything else typically included in and/or near the transaction machine.

In some embodiments, a transaction may refer to an event and/or action or group of actions facilitated or performed by a user's device, such as a user's mobile device. Such a device may be referred to herein as a transaction machine, such as transaction machine 320, and/or as a “point-of-transaction device”. A “point-of-transaction” could refer to any location, virtual location or otherwise proximate occurrence of a transaction. A “point-of-transaction device” may refer to any device used to perform a transaction, either from the user's perspective, the merchant's perspective or both. In some embodiments, the point-of-transaction device refers only to a user's device, in other embodiments it refers only to a merchant device, and in yet other embodiments, it refers to both a user device and a merchant device interacting to perform a transaction. For example, in one embodiment, the point-of-transaction device refers to the user's mobile device configured to communicate with a merchant's point-of-transaction terminal, whereas in other embodiments, the point-of-transaction device refers to the merchant's point-of-transaction terminal configured to communicate with a user's mobile device, and in yet other embodiments, the point-of-transaction device refers to both the user's mobile device and the merchant's point-of-transaction terminal configured to communicate with each other to carry out a transaction.

In some embodiments, a point-of-transaction device is or includes an interactive computer terminal that is configured to initiate, perform, complete, and/or facilitate one or more transactions. A point-of-transaction device could be or include any device that a user may use to perform a transaction with an entity, such as, but not limited to, an ATM, a loyalty device such as a rewards card, loyalty card or other loyalty device, a magnetic-based payment device (e.g., a credit card, debit card, or the like), a personal identification number (PIN) payment device, a contactless payment device (e.g., a key fob), a radio frequency identification device (RFID) and the like, a computer, (e.g., a personal computer, tablet computer, desktop computer, server, laptop, or the like), a mobile device (e.g., a smartphone, cellular phone, personal digital assistant (PDA) device, MP3 device, personal GPS device, or the like), a merchant terminal, a self-service machine (e.g., vending machine, self-checkout machine, or the like), a public and/or business kiosk (e.g., an Internet kiosk, ticketing kiosk, bill pay kiosk, or the like), a gaming device, and/or various combinations of the foregoing.

In some embodiments, a point-of-transaction device is operated in a public place (e.g., on a street corner, at the doorstep of a private residence, in an open market, at a public rest stop, or the like). In other embodiments, the point-of-transaction device is additionally or alternatively operated in a place of business (e.g., in a retail store, post office, banking center, grocery store, factory floor, or the like). In accordance with some embodiments, the point-of-transaction device is not owned by the user of the point-of-transaction device. Rather, in some embodiments, the point-of-transaction device is owned by a mobile business operator or a point-of-transaction operator (e.g., merchant, vendor, salesperson, or the like). In yet other embodiments, the point-of-transaction device is owned by the financial institution offering the point-of-transaction device providing functionality in accordance with embodiments of the invention described herein.

FIG. 3 also illustrates an authorization apparatus 330, in accordance with an embodiment of the present invention. The authorization apparatus 330 may include any computerized apparatus that can be configured to perform any one or more of the functions of the authorization apparatus 330 described and/or contemplated herein. It will also be understood that the authorization apparatus 330 can include and/or be embodied as any authorization apparatus described and/or contemplated herein. It will further be understood that the authorization apparatus 330 can initiate, perform, complete, and/or otherwise facilitate any transaction described and/or contemplated herein as being initiated, performed, and/or otherwise facilitated by an authorization apparatus. In some embodiments, the authorization apparatus 330 includes and/or is embodied as one or more servers, engines, mainframes, personal computers, ATMs, network devices, front end systems, back end systems, and/or the like. In some embodiments, such as the one illustrated in FIG. 3, the authorization apparatus 330 includes a communication interface 332, a processor 334, and a memory 336, which includes an authorization application 337 and an authorization datastore 338 stored therein. As shown, the communication interface 332 is operatively and selectively connected to the processor 334, which is operatively and selectively connected to the memory 336.

The authorization application 337 can be operable (e.g., usable, executable, or the like) to initiate, perform, complete, and/or facilitate any one or more portions of the process flows 100 and/or 200 described herein. For example, in some embodiments, the authorization application 337 is operable to receive transaction information associated with a transaction, such as a location associated with a transaction, and/or location information associated with a mobile device, such as mobile device 340. As another example, in some embodiments, the authorization application 337 is operable to determine, via processor 334, that the mobile device 340 associated with the holder 302 is located within or outside a predetermined distance from a location associated with the transaction. As still another example, in some embodiments, the authorization application 337 is operable to receive, via the communication interface 332, or authorization datastore 338 information associated with the past transactions involving holder 302 and/or a location associated with a transaction, such as information indicating that the holder 302 has regularly and/or periodically made purchases at a particular location. As another example, in some embodiments, the authorization application 337 is operable to approve or disapprove a transaction, based at least partially on a determination that the mobile device 340 associated with the holder 302 is located within or outside a predetermined distance from a location associated with the transaction. In some embodiments, the authorization application 337 is operable to complete one or more authorizations at the authorization machine 330 (e.g., approve a cash withdrawal, disapprove a credit or debit to an account, refer an account for further investigation, or the like). As still another example, in some embodiments, the authorization application 337 is operable to authorize a transaction and/or complete a transaction.

In some embodiments, the authorization application 337 is operable to enable the authorization apparatus 330 to communicate with one or more other portions of the system 300, such as, for example, the authorization datastore 338, the mobile device 340, and/or the transaction machine 320, and/or vice versa. In addition, in some embodiments, the authorization application 337 is operable to initiate, perform, complete, and/or otherwise facilitate one or more financial and/or non-financial transactions. In some embodiments, the authorization application 337 includes one or more computer-executable program code portions for causing and/or instructing the processor 334 to perform one or more of the functions of the authorization application 337 and/or the authorization apparatus 330 that are described and/or contemplated herein. In some embodiments, the authorization application 337 includes and/or uses one or more network and/or system communication protocols.

In addition to the authorization application 337, the memory 336 also includes the authorization datastore 338. It will be understood that the authorization datastore 338 can be configured to store any type and/or amount of information. For example, in some embodiments, the authorization datastore 338 includes information associated with one or more transaction machines, transaction machine users, transactions, transaction patterns and/or habits, financial accounts, electronic banking accounts, addresses associated with accounts, mobile devices, authorization requests, and/or the like. In some embodiments, the authorization datastore 338 may also store any information related to providing a misappropriation protection system. In some embodiments, the authorization datastore 338 additionally or alternatively stores information associated with electronic banking and/or electronic banking accounts.

In accordance with some embodiments, the authorization datastore 338 may include any one or more storage devices, including, but not limited to, datastores, databases, and/or any of the other storage devices typically associated with a computer system. It will also be understood that the authorization datastore 338 may store information in any known way, such as, for example, by using one or more computer codes and/or languages, alphanumeric character strings, data sets, figures, tables, charts, links, documents, and/or the like. Further, in some embodiments, the authorization datastore 338 includes information associated with one or more applications, such as, for example, the authorization application 337 and/or the transaction application 327. In some embodiments, the authorization datastore 338 provides a real-time or near real-time representation of the information stored therein, so that, for example, when the processor 334 accesses the authorization datastore 338, the information stored therein is current or nearly current. Although not shown, in some embodiments, the transaction machine 320 includes a transaction datastore that is configured to store any information associated with the transaction machine 320, the transaction application 327, and/or the like. It will be understood that the transaction datastore can store information in any known way, can include information associated with anything shown in FIG. 3, and/or can be configured similar to the authorization datastore 338.

Referring now to FIG. 3A, a block diagram is provided that illustrates the mobile device 340 of FIG. 3 in more detail, in accordance with an embodiment of the invention. In some embodiments, the mobile device 340 is a mobile phone, but in other embodiments, the mobile device 340 can include and/or be embodied as any other mobile device described and/or contemplated herein. The mobile device 340 generally includes a processor 344 operatively connected to such devices as a memory 346, user interface 349 (i.e., user output devices 349A and user input devices 349B), a communication interface 342, a power source 345, a clock or other timer 343, a camera 341, and a positioning system device 390.

The processor 344 may include the functionality to encode and interleave messages and data prior to modulation and transmission. The processor 344 can additionally include an internal data modem. Further, the processor 344 may include functionality to operate one or more software programs, which may be stored in the memory 346. For example, the processor 344 may be capable of operating a connectivity program, such as a web browser application 348. The web browser application 348 may then allow the mobile device 340 to transmit and receive web content, such as, for example, location-based content and/or other web page content, according to a Wireless Application Protocol (WAP), Hypertext Transfer Protocol (HTTP), and/or the like.

The processor 344 is configured to use the communication interface 342 to communicate with one or more other devices on the network 310. In this regard, the communication interface 342 includes an antenna 376 operatively coupled to a transmitter 374 and a receiver 372 (together a “transceiver”). The processor 344 is configured to provide signals to and receive signals from the transmitter 374 and receiver 372, respectively. The signals may include signaling information in accordance with the air interface standard of the applicable cellular system of the wireless telephone network 310. In this regard, the mobile device 340 may be configured to operate with one or more air interface standards, communication protocols, modulation types, and access types. By way of illustration, the mobile device 340 may be configured to operate in accordance with any of a number of first, second, third, and/or fourth-generation communication protocols and/or the like. For example, the mobile device 340 may be configured to operate in accordance with second-generation (2G) wireless communication protocols IS-136 (time division multiple access (TDMA)), GSM (global system for mobile communication), and/or IS-95 (code division multiple access (CDMA)), or with third-generation (3G) wireless communication protocols, such as Universal Mobile Telecommunications System (UMTS), CDMA2000, wideband CDMA (WCDMA) and/or time division-synchronous CDMA (TD-SCDMA), with fourth-generation (4G) wireless communication protocols, and/or the like. The mobile device 340 may also be configured to operate in accordance with non-cellular communication mechanisms, such as via a wireless local area network (WLAN) or other communication/data networks.

The communication interface 342 may also include a near field communication (NFC) interface 370. As used herein, the phrase “NFC interface” generally refers to hardware and/or software that is configured to contactlessly and/or wirelessly send and/or receive information over relatively short ranges (e.g., within four inches, within three feet, within fifteen feet, or the like). The NFC interface 370 may include a smart card, key card, proximity card, Bluetooth® device, radio frequency identification (RFID) tag and/or reader, transmitter, receiver, and/or the like. In some embodiments, the NFC interface 370 communicates information via radio, infrared (IR), and/or optical transmissions. In some embodiments, the NFC interface 370 is configured to operate as an NFC transmitter and/or as an NFC receiver (e.g., an NFC reader, or the like). In some embodiments, the NFC interface 370 enables the mobile device 340 to operate as a mobile wallet. Also, it will be understood that the NFC interface 370 may be embedded, built, carried, and/or otherwise supported in and/or on the mobile device 340. In some embodiments, the NFC interface 370 is not supported in and/or on the mobile device 340, but the NFC interface 370 is otherwise operatively connected to the mobile device 340 (e.g., where the NFC interface 370 is a peripheral device plugged into the mobile device 340, or the like). Other apparatuses having NFC interfaces mentioned herein may be configured similarly.

In some embodiments, the NFC interface 370 of the mobile device 340 is configured to contactlessly and/or wirelessly communicate information to and/or from a corresponding NFC interface of another apparatus (e.g., the transaction machine 320, or the like). For example, in some embodiments, the mobile device 340 is a mobile phone, the NFC interface 370 is a smart card having account information stored therein, and the transaction machine 320 is a POS and/or point-of-transaction device having an NFC reader operatively connected thereto. In such embodiments, when the mobile phone and/or smart card is brought within a relatively short range of the NFC reader, the smart card is configured to wirelessly and/or contactlessly send the account information to the NFC reader in order to, for example, initiate, perform, complete, and/or otherwise facilitate a transaction.

In addition to the NFC interface 370, the mobile device 340 can have a user interface 349 that is, like other user interfaces described herein, made up of one or more user output devices 349A and/or user input devices 349B. The user output devices 349A include a display 380 (e.g., a liquid crystal display and/or the like) and a speaker 382 and/or other audio device, which are operatively coupled to the processor 344. The user input devices 349B, which allow the mobile device 340 to receive data from a user such as the holder 302, may include any of a number of devices allowing the mobile device 340 to receive data from a user, such as a keypad, keyboard, touch-screen, touchpad, microphone, mouse, joystick, other pointer device, button, soft key, and/or other input device(s). The user interface 349 may also include a camera 341, such as a digital camera.

In some embodiments, the mobile device 340 also includes a positioning system device 390 that can be used to determine the location of the mobile device 340. For example, the positioning system device 390 may include a GPS transceiver. In some embodiments, the positioning system device 390 is at least partially made up of the antenna 376, transmitter 374, and receiver 372 described above. For example, in one embodiment, triangulation of cellular signals may be used to identify the approximate location of the mobile device 340. In other embodiments, the positioning system device 390 includes a proximity sensor and/or transmitter, such as an RFID tag, that can sense or be sensed by devices known to be located proximate a merchant and/or other location to determine that the mobile device 340 is located proximate these known devices.

The mobile device 340 further includes a power source 345, such as a battery, for powering various circuits and other devices that are used to operate the mobile device 340. Embodiments of the mobile device 340 may also include a clock or other timer 343 configured to determine and, in some cases, communicate actual or relative time to the processor 344 or one or more other devices.

The mobile device 340 also includes a memory 346 operatively connected to the processor 344. As used herein, memory includes any computer readable medium (as defined herein) configured to store data, code, and/or other information. The memory 346 may include volatile memory, such as volatile Random Access Memory (RAM) including a cache area for the temporary storage of data. The memory 346 may also include non-volatile memory, which can be embedded and/or may be removable. The non-volatile memory can additionally or alternatively include an electrically erasable programmable read-only memory (EEPROM), flash memory or the like.

The memory 346 can store any of a number of applications which may include computer-executable instructions/code executed by the processor 344 to implement the functions of the mobile device 340 described herein. For example, the memory 346 may include such applications as a web browser application 348 and/or a mobile banking application 347. It will be understood that the web browser application 348 and/or the mobile banking application 347 can be, individually or collectively, operable (e.g., usable, executable, or the like) to initiate, perform, complete, and/or facilitate any one or more portions of the process flows 100 and/or 200 described herein.

The embodiments illustrated in FIGS. 3 and 3A are exemplary and other embodiments may vary. For example, in some embodiments, some or all of the portions of the system 300 are combined into a single portion. Specifically, in some embodiments, the transaction machine 320 and the authorization apparatus 330 are combined into a single transaction and authorization apparatus that is configured to perform all of the same functions of those separate portions as described and/or contemplated herein. Likewise, in some embodiments, some or all of the portions of the system 300 are separated into two or more distinct portions. In addition, the various portions of the system 300 may be maintained by the same or separate parties.

The system 300 and/or one or more portions of the system 300 may include and/or implement any embodiment of the present invention described and/or contemplated herein. For example, in some embodiments, the system 300 (and/or one or more portions of the system 300) is configured to implement any one or more embodiments of the process flow 100 described and/or contemplated herein in connection with FIG. 1, any one or more embodiments of the process flow 200 described and/or contemplated herein in connection with FIG. 2, and/or any other process flow, method, and/or other sequence described herein.

It will be appreciated that while many of the example embodiments described herein refer to or contemplate a mobile device in the form of a mobile phone, any mobile device associated with a user and having a recognizable position may be used in example implementations of the systems and processes described herein. For example, a user's vehicle may be capable of providing GPS data. In such an example implementation, a determination that the user's vehicle is in a parking lot associated with a store or other point-of-transaction may constitute a determination that the mobile device is within a predetermined distance from a location associated with a transaction. In other example implementations, a mobile device may take the form of a personal identification number (PIN) payment device, a contactless payment device (e.g., a key fob), a radio frequency identification device (RFID) and the like, a computer, (e.g., a personal computer, tablet computer, desktop computer, server, laptop, or the like), a mobile device (e.g., a smartphone, cellular phone, personal digital assistant (PDA) device, MP3 device, personal GPS device, or the like), or any other device that a user may tend to keep on or near their person when engaging in a transaction.

While certain exemplary embodiments have been described and shown in the accompanying drawings, it is to be understood that such embodiments are merely illustrative of and not restrictive on the broad invention, and that this invention not be limited to the specific constructions and arrangements shown and described, since various other updates, combinations, omissions, modifications and substitutions, in addition to those set forth in the above paragraphs, are possible.

Those skilled in the art may appreciate that various adaptations and modifications of the just described embodiments can be configured without departing from the scope and spirit of the invention. Therefore, it is to be understood that, within the scope of the appended claims, the invention may be practiced other than as specifically described herein.

What is claimed is:

1. A system for protecting against an unauthorized transaction, the system comprising:
a computing device comprising a memory and at least one processor; and
a misappropriation protection application stored in memory, executable by the processor, and wherein the misappropriation protection application is configured to:
receive a set of information associated with a transaction, wherein the set of information associated with the transaction comprises an identification of a geographic location associated with the transaction and a predetermined distance associated with the transaction, wherein the predetermined distance is determined at least partially by a value of the transaction;
receive a set of geographic location information associated with a mobile device, wherein the mobile device is associated with an account holder associated with the transaction and wherein the set of geographic location information comprises a vector associated with a plurality of positions of the mobile device; and
determine whether to approve or disapprove the transaction based at least partially on whether or not the mobile device is geographically located within a the predetermined distance from the geographic location associated with the transaction.

2. The system of claim 1 wherein the misappropriation protection application is further configured to approve the transaction at least partially based on a determination that the mobile device is geographically located within the predetermined distance from the geographic location associated with the transaction.

3. The system of claim 2 wherein the misappropriation protection application is further configured to receive a set of data associated with the account holder associated with the transaction, wherein the set of data comprises information associated with a plurality of previously approved transactions, and wherein said misappropriation protection application is further configured to approve the transaction based at least partially on both determining that the mobile device is geographically located within the predetermined distance from the geographic location associated with the transaction and the information associated with a plurality of previously approved transactions.

4. The system of claim 3 wherein the misappropriation protection application is further configured to approve the transaction based at least partially on identifying a previously approved transaction within the plurality of previously approved transactions, wherein the previously approved transaction is associated with the same location as the transaction.

5. The system of claim 1 wherein the misappropriation protection application is further configured to:
determine that the mobile device is geographically located outside the predetermined distance from the geographic location associated with the transaction; and
refer the transaction for further investigation based at least partially on determining that the mobile device is geographically located outside the predetermined distance from the geographic location associated with the transaction.

6. The system of claim 5 wherein the misappropriation protection application is further configured to receive a set of data associated with the account holder associated with the transaction, wherein the set of data comprises information associated with a plurality of previously approved transactions.

7. The system of claim 6 wherein the misappropriation protection application is further configured to approve the transaction based at least partially on identifying a previously approved transaction within the plurality of previously approved transactions, wherein the previously approved transaction is associated with the same location as the transaction.

8. The system of claim 4 wherein the misappropriation protection application is further configured to cause an alert to be transmitted to one or more devices associated with the account holder.

9. A method for protecting against an unauthorized transaction, the method comprising:
receiving a set of information associated with a transaction, wherein the set of information associated with the transaction comprises an identification of a geographic location associated with the transaction and a predetermined distance associated with the transaction, wherein the predetermined distance is determined at least partially by a value of the transaction;
receiving a set of geographic location information associated with a mobile device, wherein the mobile device is associated with an account holder associated with the transaction and wherein the set of geographic location information comprises a vector associated with a plurality of positions of the mobile device; and
determining, whether to approve or disapprove the transaction based at least partially on whether or not the mobile device is geographically located within a the predetermined distance from the geographic location associated with the transaction.

10. The method of claim 9 further comprising approving the transaction at least partially based on a determination that the mobile device is geographically located within the predetermined distance from the geographic location associated with the transaction.

11. The method of claim 10 further comprising receiving a set of data associated with the account holder associated with the transaction, wherein the set of data comprises information associated with a plurality of previously approved transactions.

12. The method of claim 11 further comprising approving the transaction based at least partially on identifying a previously approved transaction within the plurality of previously approved transactions, wherein the previously approved transaction is associated with the same location as the transaction.

13. The method of claim 9 further comprising:
determining that the mobile device is geographically located outside the predetermined distance from the geographic location associated with the transaction; and
referring the transaction for further investigation based at least partially on determining that the mobile device is geographically located outside the predetermined distance from the geographic location associated with the transaction.

14. The method of claim 13 further comprising receiving a set of data associated with the account holder associated with the transaction, wherein the set of data comprises information associated with a plurality of previously approved transactions.

15. The method of claim 14 further comprising approving the transaction based at least partially on identifying a previously approved transaction within the plurality of previously approved transactions, wherein the previously approved transaction is associated with the same location as the transaction.

16. The method of claim 13 further comprising causing an alert to be transmitted to one or more devices associated with the account holder.

17. A computer program product comprising:
a non-transitory computer-readable medium having computer-readable program code portions embodied therein, the computer-readable program code portions comprising:
an executable portion configured for receiving a set of information associated with a transaction, wherein the set of information associated with the transaction comprises an identification of a geographic location associated with the transaction and a predetermined distance associated with the transaction, wherein the predetermined distance is determined at least partially by a value of the transaction;
an executable portion configured for receiving a set of geographic location information associated with a mobile device, wherein the mobile device is associated with an account holder associated with the transaction and wherein the set of geographic location information comprises a vector associated with a plurality of positions of the mobile device; and
an executable portion configured for determining whether to approve or disapprove the transaction based at least partially on whether or not the mobile device is geographically located within the predetermined distance from the geographic location associated with the transaction.

18. The computer program product of claim 17 further comprising an executable portion configured for approving the transaction at least partially based on a determination that the mobile device is geographically located within a predetermined distance from the geographic location associated with the transaction.

19. The computer program product of claim 18 further comprising an executable portion configured for receiving a set of data associated with the account holder associated with the transaction, wherein the set of data comprises information associated with a plurality of previously approved transactions, and further approving the transaction based at least partially on both determining that the mobile device is geographically located within the predetermined distance from the geographic location associated with the transaction and the information associated with a plurality of previously approved transactions.

20. The computer program product of claim 19 further comprising an executable portion configured for approving the transaction based at least partially on identifying a previously approved transaction within the plurality of previously approved transactions, wherein the previously approved transaction is associated with the same location as the transaction.

21. The computer program product of claim 17 further comprising:
an executable portion configured for determining that the mobile device is geographically located outside the predetermined distance from the geographic location associated with the transaction; and
an executable portion configured for referring the transaction for further investigation based at least partially on determining that the mobile device is geographically located outside the predetermined distance from the geographic location associated with the transaction.
